(19) United States
(12) Patent Application Publication
(10) Pub. No.: US 2010/0017445 A1
(43) Pub. Date: Jan. 21, 2010

(54) BACKUP CONTROL METHOD AND BACKUP CONTROL DEVICE

(75) Inventor: Eiichi Kobayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/569,566

(22) Filed: Sep. 29, 2009

Related U.S. Application Data
(63) Continuation of application No. PCT/JP2007/057231, filed on Mar. 30, 2007.

(51) Int. Cl. G06F 12/16; G06F 12/00

(52) U.S. Cl. 707/204; 707/E17.01; 707/E17.044; 711/E12.001; 711/E12.103

(57) ABSTRACT

A backup control unit controls a normal backup process of backing up a file stored in a NAS device at file system level according to a task schedule set in advance, and controls a forcible backup process of forcibly backing up the file stored in the NAS device at file level upon being triggered by detection of file close of a file stored in a forcible-backup-target file list by an access monitoring unit.

### CROSS-REFERENCE TO RELATED APPLICATION(S)

This application is a continuation of International Application No. PCT/JP2007/057231, filed on Mar. 30, 2007, the entire contents of which are incorporated herein by reference.

### FIELD

The embodiments discussed herein is directed to a backup control that causes a computer device to execute a backup control process of controlling a backup device that executes a backup process of backing up backup target files stored in a storage device.

### BACKGROUND

Conventionally, it is a common procedure to back up data to be stored in a storage device, into other storage device. This makes it possible to avoid loss of data by reading it from this other storage device, when the data cannot be read from the storage device due to a failure in the storage device itself or a trouble generated in a storage medium.

Performing the backup as described above can avoid troubles such as breakage and loss of files, even when a certain file included in data stored in the storage device is broken or even when the file is mistakenly erased.

In such a file backup method, if a file is opened at a time of backing up, it is in the middle of being updated. Accordingly, when the file is backed up at this time, the backed up file is incomplete. Therefore, various techniques of increasing reliability of backup of an opened file while keeping consistency of the file have been made up.

For example, according to a file backup method disclosed in Japanese Laid-open Patent Publication No. 2003-280965, while performing a synchronization process between a backup source file and a replica file thereof, the replica file is copied in a backup destination file upon being triggered by file close of the backup source file, thereby performing the backup of the file.

A data duplicating system disclosed in Japanese Laid-open Patent Publication No. 2000-82004 can define a backup timing for each file, and the system can back up the corresponding file upon being triggered by a predetermined timing.

According to an in-use-file saving method disclosed in Japanese Laid-open Patent Publication No. 05-181728, when backup of a file is instructed, a program using a backup source file is temporarily suspended, and access state information of an access of the program to the backup source file is obtained. The access state information is then backed up in a backup destination file together with the backup source file, thereby making it possible to determine a final state of a backup time of the backup source file. With this arrangement, the backup destination file can be used similarly to the backup source file.

A data backup/restore device disclosed in Japanese Laid-open Patent Publication No. 10-312329 includes a data accumulating device having a bandwidth capable of simultaneously performing data input/output and data backup, and can record file data into the data accumulating device simultaneously with backing up of the file data.

A file saving device disclosed in Japanese Laid-open Patent Publication No. 08-328927 holds a queue of files to be backed up. When a file is opened, the file saving device deletes the file from the queue, and when the file is closed, the file saving device registers the file into the queue again. An automatic backup unit of the file saving device automatically backs up a file registered in the queue.

However, according to the conventional techniques represented by Japanese Laid-open Patent Publication No. 2003-280965 and Japanese Laid-open Patent Publication No. 2000-82004 mentioned above, even when open/close of each backup source file can be monitored, control of backing up each file triggered by closing of the file becomes difficult due to processing capacity of a computer and resource constraints, because a storage device has a considerably large capacity and the number of files stored in the storage device is huge in recent years.

According to the conventional technique represented by Japanese Laid-open Patent Publication No. 05-181728 mentioned above, similarly to the conventional techniques of Japanese Laid-open Patent Publication No. 2003-280965 and Japanese Laid-open Patent Publication No. 2000-82004, it is difficult to obtain information of a final state of each backup source file by temporarily suspending a program using the file and to back up the obtained information to a backup destination file together with the backup source file, due to processing capacity of a computer and resource constraints, because a storage device has a considerably large capacity and the number of files stored in the storage device is huge in recent years.

According to the conventional technique represented by Japanese Laid-open Patent Publication No. 10-312329 mentioned above, similarly to the conventional techniques of Japanese Laid-open Patent Publication No. 2003-280965, Japanese Laid-open Patent Publication No. 2000-82004, and Japanese Laid-open Patent Publication No. 05-181728, control of recording file data into a data storage device for each file simultaneously with backing up the file data is difficult, due to processing capacity of a computer and resource constraints, because a storage device has a considerably large capacity and the number of files stored in the storage device is huge in recent years.

According to the conventional technique represented by Japanese Laid-open Patent Publication No. 08-328927 mentioned above, an opened file is not backed up, and only a closed file is backed up. Because an opened file is not backed up so long as the file is opened, a file that is kept continuously opened for a long time loses an opportunity of being backed up in a latest state. Even when a backup of the file exists, it is possible that this backup is in an old state, and cannot be used for recovery.

### SUMMARY

According to an aspect of an embodiment of the invention, a backup control method for performing a backup control process of controlling a backup device that performs a backup process of backing up a backup target file stored in a storage device, includes detecting file open and file close of the backup target file; storing specific information of the backup target file of which file open is detected at the detecting at the backup process; and instructing the backup device to back up the backup target file when file close of the backup target file of which specific information is stored at the storing is detected at the detecting.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 depicts a network configuration including a backup control device and a NAS device according to an embodiment and a functional configuration of the backup control device and the NAS device;

FIG. 2 depicts an example of a backup-target-file system list;

FIG. 3 depicts an example of an accessed file list;

FIG. 4 depicts an example of a backup-incomplete-file temporary list;

FIG. 5 depicts an example of a backup-incomplete file list;

FIG. 6 depicts an example of a forcible-backup-target file list;

FIG. 7 is a flowchart of an access-monitoring process procedure in the backup control device;

FIG. 8 is a flowchart of a normal backup process procedure in the backup control device; and

FIG. 9 is a flowchart of a forcible-backup process procedure in the backup control device.

### DESCRIPTION OF EMBODIMENT(S)

A preferred embodiment of the present invention will be explained with reference to accompanying drawings. In the following embodiment, a storage device is applied to a network attached storage (NAS) device that is operated as a file server. However, application thereof is not limited thereto, and the storage device can be also applied to devices such as storage area network (SAN) devices, magnetic disk devices, optical disk devices, and magnetic optical disk devices.

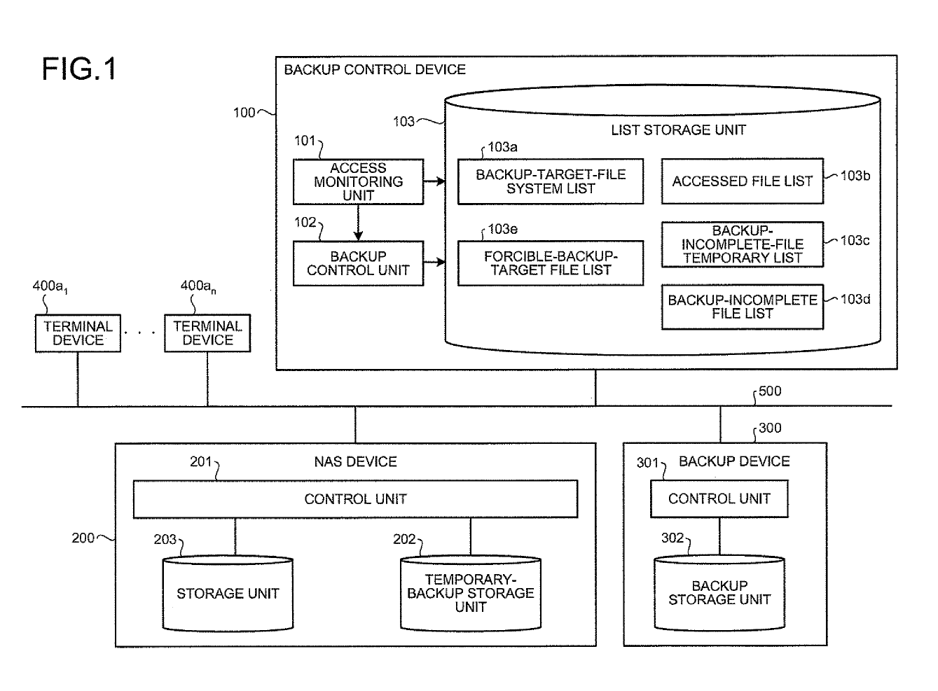

A network configuration including a backup control device and a NAS device and a functional configuration of the backup control device and the NAS device according to an embodiment are explained first. FIG. 1 depicts the network configuration including the backup control device and the NAS device according to the embodiment and the functional configuration of the backup control device and the NAS device.

As depicted in FIG. 1, a backup control device 100, a NAS device 200, a backup device 300, and terminal devices 400a₁, . . . , 400aₙ such as personal computers and the like are connected to each other via a LAN 500.

In response to operations by a user, files stored in the NAS device 200 can be accessed from the terminal devices 400a₁, . . . , 400aₙ. File access includes file open, file update, and file close. A file that is opened but is not closed is a file being accessed.

Files stored in the NAS device 200 are shared files that can be simultaneously accessed by multiple users. The files stored in the NAS device 200 are finally backed up in the backup device 300 by control of the backup control device 100 via the LAN 500.

The backup control device 100 includes an access monitoring unit 101, a backup control unit 102, and a list storage unit 103. The access monitoring unit 101 monitors file open and file close of files stored in the NAS device 200 from the terminal devices 400a₁, . . . , 400aₙ.

The backup control unit 102 controls a normal backup process of backing up a file stored in the NAS device 200 at file system level according to a task schedule set in advance, and controls a forcible backup process of forcibly backing up the file stored in the NAS device 200 at file level upon being triggered by detection of file close by the access monitoring unit 101.

The list storage unit 103 stores a backup-target-file system list 103a, an accessed file list 103b, a backup-incomplete-file temporary list 103c, a backup-incomplete file list 103d, and a forcible-backup-target file list 103e.

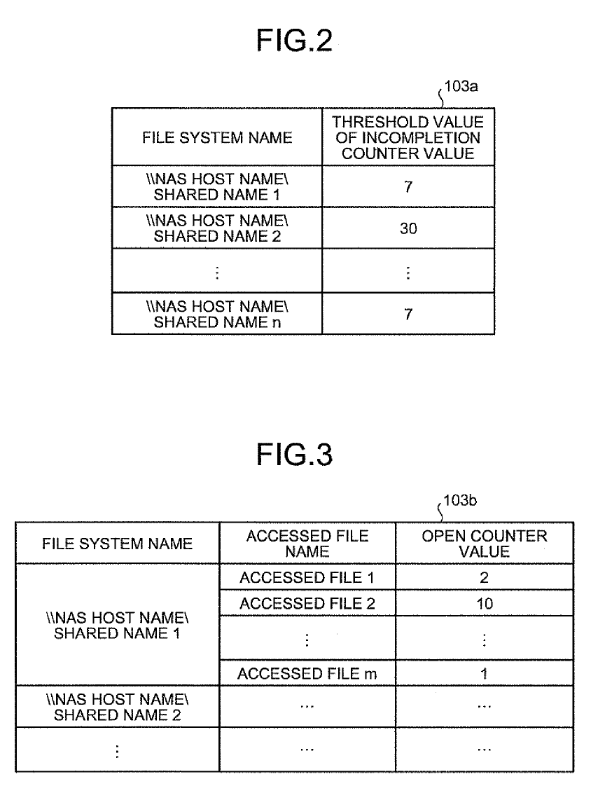

The backup-target-file system list 103a stores file system names of file systems to be normally backed up, to make it possible to specify file systems to be normally backed up, as depicted in FIG. 2 for example. The backup-target-file system list 103a also stores thresholds of incompletion counter values corresponding respectively to file system names. Each of the thresholds of the incompletion counter values is a threshold of the incompletion counter value stored in the backup-incomplete file list 103d.

The accessed file list 103b stores accessed file names of accessed files, together with file system names of the file systems to which the files belong, to make it possible to specify files being accessed from the terminal devices 400a₁, . . . , 400aₙ, as depicted in FIG. 3 for example. The accessed file list 103b also stores open counter values corresponding respectively to files whose names are stored in the accessed file list 103b. The open counter value expresses the number of users currently accessing the corresponding file.

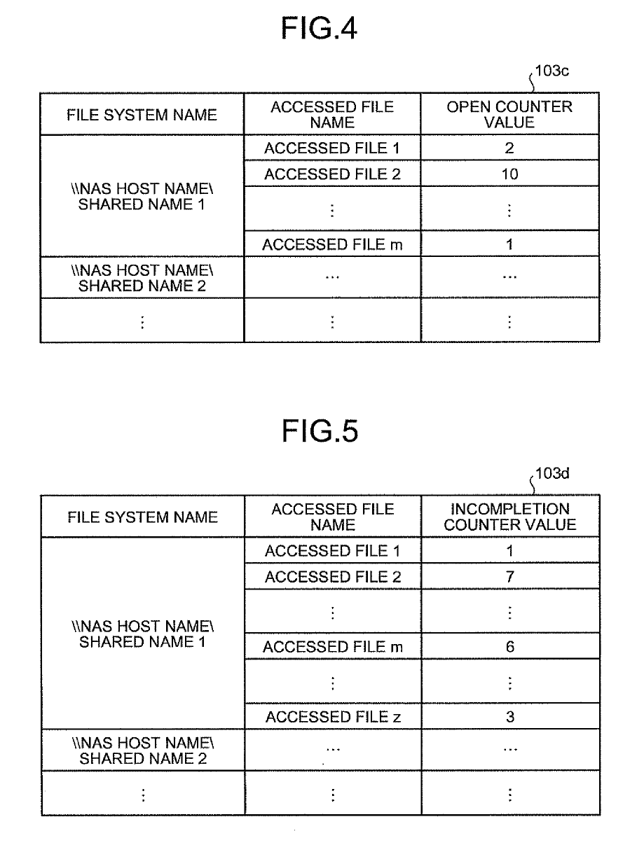

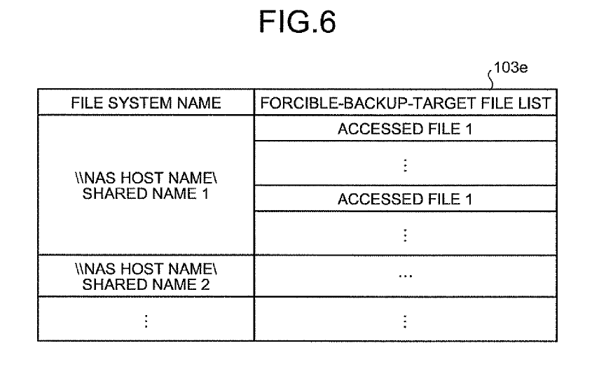

The backup-incomplete-file temporary list 103c is a list generated by copying the accessed file list 103b at a predetermined time, as depicted in FIG. 4 for example. The predetermined time is a time when the backup control unit 102 performs a normal backup process, for example. That is, the backup-incomplete-file temporary list 103c is a list of files of which normal backup is unsuccessful at the predetermined time.

The backup-incomplete file list 103d is a list that sums up stored contents of the backup-incomplete-file temporary list 103c. The backup-incomplete file list 103d sequentially adds file names together with file system names listed in the backup-incomplete-file temporary list 103c generated at each of the predetermined time and sets the incompletion counter value to 1, as depicted in FIG. 5 for example. When entry of a file name listed in the backup-incomplete-file temporary list 103c exists, the backup-incomplete file list 103d stores a value obtained by incrementing the incompletion counter value. That is, files listed in the backup-incomplete file list 103d are files of which normal backup is unsuccessful. By incrementing the incompletion counter value each time when the backup-incomplete file list 103d is generated, the incompletion counter value expresses the number of times when the normal backup of each file is unsuccessful.

When the incompletion counter value exceeds the threshold of the incompletion counter value of the backup-target-file system list 103a, entry of the corresponding file is added to the forcible-backup-target file list 103e.

Entry of a file uniquely specified by a file system name and by an accessed file name in the backup-incomplete file list 103d is deleted after forcible backup is performed.

The forcible-backup-target file list 103e is a list that stores forcible-backup target files. A file uniquely specified by a file system name and by a forcible-backup-target file name is a file to be forcibly backed up when an open counter value of the accessed file list 103b becomes 0.

The NAS device 200 includes a control unit 201 that controls the entirety of the NAS device 200, a temporary-backup storage unit 202, and a storage unit 203. The temporary-backup storage unit 202 and the storage unit 203 are storage mediums such as a magnetic disk.

The temporary-backup storage unit 202 is a storage unit obtained by copying all stored contents of the storage unit 203 at a high speed in a file system unit via control of the control unit 201, to extract forcible-backup target files from the storage unit 203. The high-speed copying is performed upon being triggered by an operation that the access monitoring unit 101 of the backup control device 100 detects file close. When high-speed copying of the storage unit 203 is generated in this way, it becomes possible to extract forcible-backup target files in a state of the time when the access monitoring unit 101 of the backup control device 100 detects file close. In the normal backup, all stored contents of the storage unit 203 are copied in the backup device 300 via control of the control unit 201.

The backup device 300 includes a control unit 301 that controls the entirety of the backup device 300, and a backup storage unit 302. The backup storage unit 302 is a recording medium such as a magnetic disk. In the normal backup, all stored contents of the storage unit 203 are copied in the backup storage unit 302 via the control unit 201 of the NAS device 200 and the control unit 301 of the backup device 300. On the other hand, in the forcible backup, forcible-backup target files in the temporary-backup storage unit 202 are copied in the backup storage unit 302 via the control unit 201 of the NAS device 200 and the control unit 301 of the backup device 300.

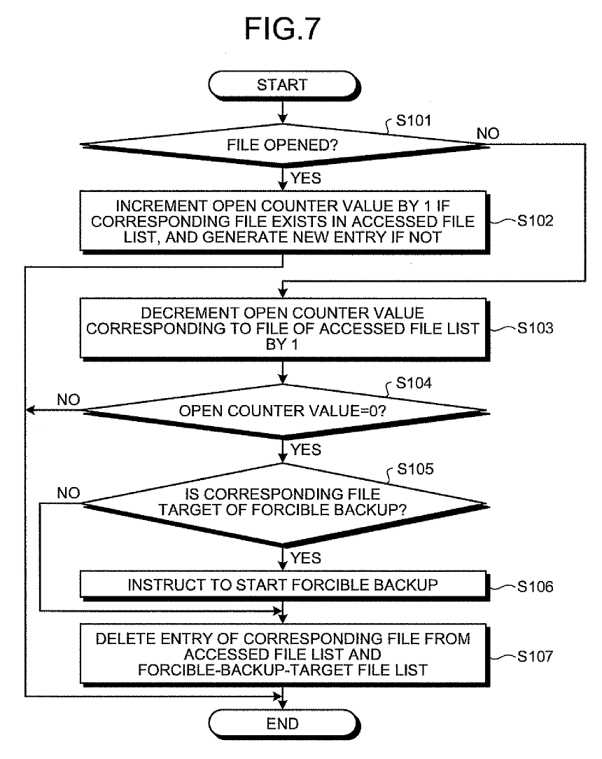

An access monitoring process in the backup control device is explained next. FIG. 7 is a flowchart of an access-monitoring process procedure in the backup control device. The access monitoring process is performed each time when file open or file close is detected.

As depicted in FIG. 7, the access monitoring unit 101 first determines whether file open is detected (Step S101). When it is determined that file open is detected (YES at Step S101), the process proceeds to Step S102. When it is determined that file open is not detected (that is, when a file is closed) (NO at Step S101), the process proceeds to Step S103.

When an opened file exists in the accessed file list 103b at Step S101, the access monitoring unit 101 increments the corresponding open counter by 1 at Step S102. When an opened file does not exist in the accessed file list 103b at Step S101, the access monitoring unit 101 generates new entry of the file in the accessed file list 103b. At the time of generating new entry, the open counter value is set to 1. When Step S102 is finished, the access monitoring process is finished.

Meanwhile, at Step S103, the access monitoring unit 101 decrements by 1 the open counter value of the accessed file list 103b of the file of which file close is detected.

At Step S104 following Step S103, the access monitoring unit 101 determines whether the open counter value of a file of which file close is detected is 0. When it is determined that the open counter value of a file of which file close is detected is 0 (YES at Step S104), the process proceeds to Step S105. When it is determined that the open counter value of a file of which file close is detected is not 0 (NO at Step S104), the access monitoring process is finished.

At Step S105, the access monitoring unit 101 determines whether a file of which file close is detected is a forcible-backup target file stored in the forcible-backup-target file list 103e. When it is determined that a file of which file close is detected is a forcible-backup target file (YES at Step S105), the process proceeds to Step S106. When it is determined that a file of which file close is detected is not a forcible-backup target file (NO at Step S105), the process proceeds to Step S107.

At Step S106, the access monitoring unit 101 instructs the backup control unit 102 to forcibly back up the corresponding file (Step S106). After Step S106 is finished, the process proceeds to Step S107. At Step S107, the access monitoring unit 101 deletes the entry of files forcibly backed up from the accessed file list 103b and the forcible-backup-target file list 103e.

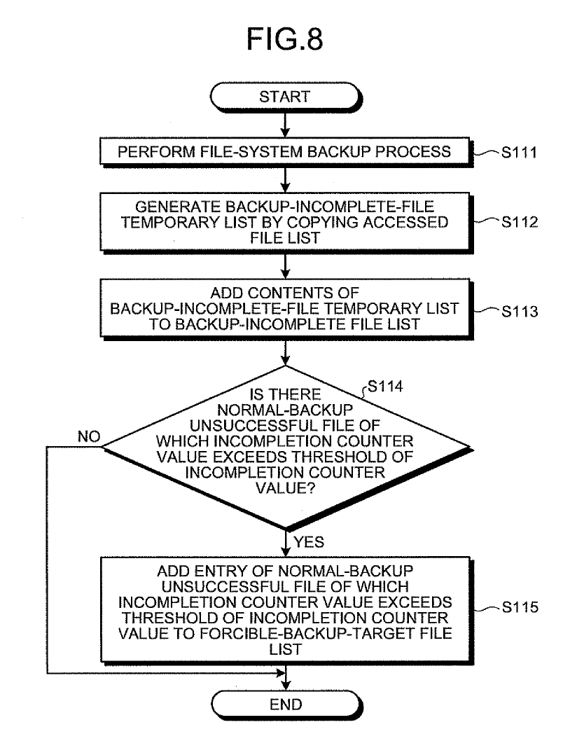

A normal backup process in the backup control device is explained next. FIG. 8 is a flowchart of a normal backup process procedure in the backup control device. The normal backup process is periodically performed according to a task schedule set in advance in the backup control device 100.

The backup control unit 102 first performs a file-system backup process to the NAS device 200 (Step S111). Next, the backup control unit 102 copies the accessed file list 103b and generates the backup-incomplete-file temporary list 103c (Step S112). Based on the backup-incomplete-file temporary list 103c, a normal-backup unsuccessful file of which normal back is unsuccessful is recognized.

The backup control unit 102 then adds file names together with their file system names stored in the backup-incomplete-file temporary list 103c to the backup-incomplete file list 103d as backup unsuccessful files, and sets the incompletion counter value to 1. When a file name stored in the backup-incomplete-file temporary list 103c is already entered in the backup-incomplete file list 103d, the backup control unit 102 increments the incompletion counter value (Step S113). The backup control unit 102 compares the incompletion counter value of the backup-incomplete file list 103d with the threshold of the incompletion counter value of the backup-target-file system list 103a, and determines whether there is a normal-backup unsuccessful file of which the incompletion counter value exceeds the threshold of the incompletion counter value (Step S114).

When it is determined that there is a normal-backup unsuccessful file of which the incompletion counter value exceeds the threshold of the incompletion counter value (YES at Step S114), the process proceeds to Step S115. When it is determined that there is no normal-backup unsuccessful file of which the incompletion counter value exceeds the threshold of the incompletion counter value (NO at Step S114), the normal backup process is finished. At Step S115, entry of a backup-unsuccessful file of which the incompletion counter value exceeds the threshold of the incompletion counter value is added to the forcible-backup-target file list 103e as a forcible-backup target file.

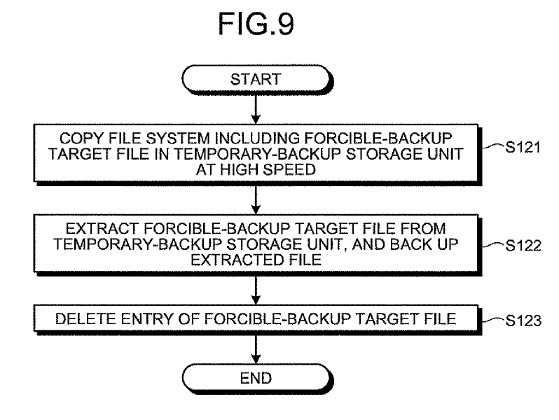

A forcible backup process in the backup control device is explained next. FIG. 9 is a flowchart of a forcible-backup process procedure in the backup control device. The forcible backup process is performed each time when file close is detected.

The backup control unit 102 first copies at a high speed a file system including a forcible-backup target file, to the temporary-backup storage unit 202 (Step S121). The backup control unit 102 then extracts the forcible-backup target file from the temporary-backup storage unit 202, and backs up the file in the backup storage unit 302 (Step S122). The backup control unit 102 deletes entry of the forcible-backup target file from the forcible-backup-target file list 103e (Step S123).

According to the above embodiment, at the time of performing recovery, a forcible-backup target file is forcibly backed up when file access is 0 at the file close time. Therefore, it is not necessary to search to which backup generation a complete backup of a backup target file belongs.

By properly assigning a schedule of normal backup and a threshold of an incompletion counter value by balancing between the schedule and the threshold, a file can be backed up in a state that a file operation is always completed at a specific interval.

By narrowing down forcible-backup target files in such a manner that only files of which the number of unsuccessful times of normal backup exceeds a predetermined threshold value are to be backed up instead of setting all incomplete-backup files as forcible-backup target files, the frequency of forcible backup and the number of forcible-backup target files can be suppressed. As a result, even a large-scale file server can perform efficient backup.

While an embodiment of the present invention has been explained above, the invention is not limited thereto, and variously modified embodiments can be made without departing from the scope of the technical spirit described in the claims. In addition, the effects described in the embodiment do not limit the range of effects of the present invention.

For example, the access monitoring unit 101 and the backup control unit 102 of the backup control device 100 can be provided in the control unit 201 of the NAS device 200. In this case, the NAS device 200 includes the list storage unit 103 in its configuration. In the above embodiment, while the backup device 300 is described to have a configuration separately from that of the NAS device 200, the backup device 300 can be configured to be included in the NAS device 200.

In the above embodiment, stored contents of the backup-incomplete-file temporary list 103c are added to the backup-incomplete file list 103d, and thus forcible backup is performed when the incompletion counter value as a cumulative value of the number of times of unsuccessful backup exceeds the threshold of the incompletion counter value. Consequently, even when a file is incompletely backed up by a few times of normal backup, the file is not determined each time as a forcible-backup target file, and the file is forcibly backed up only when the file is incompletely backed up by a certain number of times of normal backup. By selecting forcible-backup target file files in this way, the processing load of forcible backup can be reduced. However, the configuration is not limited thereto, and a file of which backup is unsuccessful can be immediately determined as a forcible-backup target file, without adding stored contents of the backup-incomplete-file temporary list 103c to the backup-incomplete file list 103d. With this arrangement, a generating procedure of the backup-incomplete-file temporary list 103c and the backup-incomplete file list 103d can be omitted, the processing load can be reduced, and computer resources necessary for the process can be reduced.

Among the respective processes described in the above embodiment, all or a part of the processes explained as being performed automatically can be performed manually, or all or a part of the processes explained as being performed manually can be performed automatically by a known method. In addition, process procedures, control procedures, specific names, and information including various kinds of data and parameters mentioned in the above embodiment can be arbitrarily changed unless otherwise specified.

The respective constituent elements of each of the devices depicted in the drawings are functionally conceptual, and physically the same configuration is not always necessary. That is, the specific mode of distribution and integration of the devices are not limited to the depicted ones, and all or a part thereof can be functionally or physically distributed or integrated in an arbitrary unit, according to various kinds of load and the status of use.

Furthermore, all or any part of each processing function performed by the respective devices can be realized by a central processing unit (CPU) (or a microcomputer such as a micro processing unit (MPU) and a micro controller unit (MCU)), or by a program analyzed and executed in the CPU (or a microcomputer such as a MPU and MCU), or realized as hardware by a wired logic.

Each process described in the above embodiment is realized by a program and a computer device that executes the program, and the program can be distributed by storing it on a storage medium such as a magnetic disk, an optical disk, a magnetic optical disk, and a semiconductor memory. In addition, the program can be distributed via a network.

According to an embodiment of the present invention, by storing a file opened during a backup process, the file can be backed up when it is closed.

According to an embodiment of the present invention, by storing a file opened during a normal backup process, when the file is closed, it can be backed up by a forcible backup process performed at a timing different from that of the normal backup.

According to an embodiment of the present invention, only a specific file can be forcibly backed up.

According to an embodiment of the present invention, a file of which normal backup has been unsuccessful can be forcibly backed up promptly.

According to an embodiment of the present invention, the processing load of a forcible backup process can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer readable storage medium having stored therein a backup control program for performing a backup control process of controlling a backup device that performs a backup process of backing up a backup target file stored in a storage device, the backup control program causing a computer to execute processing procedure comprising:
detecting file open and file close of the backup target file;
storing specific information of the backup target file of which file open is detected at the detecting at the backup process; and
instructing the backup device to back up the backup target file when file close of the backup target file of which specific information is stored at the storing is detected at the detecting.

2. The computer readable storage medium according to claim 1, wherein
the backup process includes a normal backup process to be started according to a schedule set in advance, and a forcible backup process to be arbitrarily started irrespective of the schedule,
the storing includes storing specific information of the backup target file of which file open is detected at the detecting at the normal backup process, and
the backup of the backup target file instructed at the instructing is the forcible backup process.

3. The computer readable storage medium according to claim 2, wherein the normal backup process backs up the backup target file at file system level, and the forcible backup process backs up the backup target file at file level.

4. The computer readable storage medium according to claim 3, wherein
the storing includes storing, together with the specific information, the number of file accesses incremented in response to the detection of file open of the backup target file and decremented in response to the detection of file close of the backup target file, and
the processing procedure further comprises
storing specific information of a normal-backup unsuccessful file at the normal backup process, the normal-backup unsuccessful file being the backup target file of which the number of file accesses stored at the storing is not 0; and
instructing the backup device to back up the normal-backup unsuccessful file by extracting the normal-backup unsuccessful file if the number of file accesses of the normal-backup unsuccessful file stored at the storing is 0, when file close of the normal-backup unsuccessful file stored at the storing is detected at the detecting.

5. The computer readable storage medium according to claim 4, wherein
the processing procedure further comprises:
accumulating the number of times when the backup target file is determined to be the normal-backup unsuccessful file at the storing, each time when the normal backup process is started; and
storing specific information of a forcible-backup target file, the forcible-backup target file being the backup target file when the number of times accumulated by the normal-backup-unsuccessful-number accumulating procedure exceeds a predetermined threshold value, and
the instructing includes instructing the backup device to back up the forcible-backup target file by extracting the forcible-backup target file if the number of file accesses of the forcible-backup target file stored at the storing is 0, when file close of the forcible-backup target file is detected at the detecting.

6. A backup control device for performing a backup control process of controlling a backup device that performs a backup process of backing up a backup target file stored in a storage device, the backup control device comprising:
a file open/close detecting unit that detects file open and file close of the backup target file;
an open-file storing unit that stores specific information of the backup target file of which file open is detected by the file open/close detecting unit at the backup process; and
a backup instructing unit that instructs the backup device to back up the backup target file when file close of the backup target file of which specific information is stored by the open-file storing unit is detected by the file open/close detecting unit.

7. The backup control device according to claim 6, wherein
the backup process includes a normal backup process to be started according to a schedule set in advance, and a forcible backup process to be arbitrarily started irrespective of the schedule,
the open-file storing unit stores specific information of the backup target file of which file open is detected by the file open/close detecting unit at the normal backup process, and
the backup of the backup target file instructed by the backup instructing unit is the forcible backup process.

8. The backup control device according to claim 7, wherein the normal backup process backs up the backup target file at file system level, and the forcible backup process backs up the backup target file at file level.

9. The backup control device according to claim 8, wherein
the open-file storing unit stores, together with the specific information, the number of file accesses incremented in response to detection of file open of the backup target file and decremented in response to detection of file close of the backup target file, and
the backup control device further comprises:
a normal-backup-failure storing unit that stores specific information of a normal-backup unsuccessful file at the normal backup process, normal-backup unsuccessful file being the backup target file of which the number of file accesses stored by the open-file storing unit is not 0; and
a forcible-backup instructing unit that instructs the backup device to back up the normal-backup unsuccessful file by extracting the normal-backup unsuccessful file if the number of file accesses of the normal-backup unsuccessful file stored by the open-file storing unit is 0, when file close of the normal-backup unsuccessful file stored by the normal-backup-failure storing unit is detected.

10. The backup control device according to claim 9, further comprising:
a normal-backup-unsuccessful-number accumulating unit that accumulates the number of times when the backup target file is determined to be the normal-backup unsuccessful file by the normal-backup-failure storing unit, each time when the normal backup process is started; and
a forcible-backup-target storing unit that stores specific information of a forcible-backup target file, the forcible-backup target file being the backup target file when the number of times accumulated by the normal-backup-unsuccessful-number accumulating unit exceeds a predetermined threshold value, wherein
the forcible-backup instructing unit instructs the backup device to back up the forcible-backup target file by extracting the forcible-backup target file if the number of file accesses of the forcible-backup target file stored by the open-file storing unit is 0, when file close of the forcible-backup target file is detected by the file open/close detecting unit.

11. A backup control method for performing a backup control process of controlling a backup device that performs a backup process of backing up a backup target file stored in a storage device, the backup control method comprising:
detecting file open and file close of the backup target file;
storing specific information of the backup target file of which file open is detected at the detecting at the backup process; and
instructing the backup device to back up the backup target file when file close of the backup target file of which specific information is stored at the storing is detected at the detecting.

12. The backup control method according to claim 11, wherein
the backup process includes a normal backup process to be started according to a schedule set in advance, and a forcible backup process to be arbitrarily started irrespective of the schedule,
the storing includes storing specific information of the backup target file of which file open is detected at the detecting at the normal backup process, and
the backup of the backup target file instructed at the instructing is the forcible backup process.

13. The backup control method according to claim 12, wherein the normal backup process backs up the backup target file at file system level, and the forcible backup process backs up the backup target file at file level.

14. The backup control method according to claim 13, wherein
the storing includes storing, together with the specific information, the number of file accesses incremented in response to the detection of file open of the backup target file and decremented in response to the detection of file close of the backup target file, and
the backup control method further comprises
storing specific information of a normal-backup unsuccessful file at the normal backup process, the normal-backup unsuccessful file being the backup target file of which the number of file accesses stored at the storing is not 0; and
instructing the backup device to back up the normal-backup unsuccessful file by extracting the normal-backup unsuccessful file if the number of file accesses of the normal-backup unsuccessful file stored at the storing is 0, when file close of the normal-backup unsuccessful file stored at the storing is detected at the detecting.

15. The backup control method according to claim 14, further comprising:
accumulating the number of times when the backup target file is determined to be the normal-backup unsuccessful file at the storing, each time when the normal backup process is started; and
storing specific information of a forcible-backup target file, the forcible-backup target file being the backup target file when the number of times accumulated by the normal-backup-unsuccessful-number accumulating procedure exceeds a predetermined threshold value, wherein
the instructing includes instructing the backup device to back up the forcible-backup target file by extracting the forcible-backup target file if the number of file accesses of the forcible-backup target file stored at the storing is 0, when file close of the forcible-backup target file is detected at the detecting.
